(19) United States
(12) Patent Application Publication
(10) Pub. No.: US 2015/0135694 A1
(43) Pub. Date: May 21, 2015

(54) Gearbox Hydraulic Circuit

(71) Applicant: Turner Powertrain Systems Limited, West Midlands (GB)

(72) Inventor: John Wootton, Telford (GB)

(73) Assignee: Turner Powertrain Systems Limited, West Midlands (GB)

(21) Appl. No.: 14/405,516

(22) PCT Filed: Jun. 17, 2013
(86) PCT No.: PCT/EP2013/062515

§ 371 Date: Dec. 4, 2014

(30) Foreign Application Priority Data
Jun. 19, 2012 (EP) 12172597.2

(51) Int. Cl. F15B 11/10; F15B 13/042; F15B 13/043

(52) U.S. Cl. CPC F15B 11/10; F15B 13/043; F15B 13/042; F15B 2211/505; F15B 2211/526
USPC 60/327; 60/459; 60/435

(57) ABSTRACT

A gearbox hydraulic circuit includes a hydraulic pump connected to a fluid reservoir to generate a flow of pressurised fluid. A pressure circuit connected to the hydraulic pump conveys the flow of pressurised fluid. A pressure control valve disposed in the pressure circuit between the first line and the second line of the pressure circuit maintains the pressure of the pressurised fluid in the first line. A shunt connected to the pressure circuit is operable to route the flow of pressurised fluid from the first line to the second line to reduce the pressure in the first line.

### TECHNICAL FIELD

This disclosure generally relates to hydraulic control systems for work machines, and more particularly to gearbox hydraulic circuits for work machines.

### BACKGROUND

Vehicles, such as, for example, highway trucks and work machines, may include hydraulic control systems having hydraulic pumps. Hydraulic pumps may be used in various applications. Work machines, such as hydraulic excavators, back hoes or loaders, may have hydraulic pumps that are engine driven to generate a flow of pressurised fluid. The pressurised fluid may be used for a variety of purposes during operation of the vehicle. A work machine, for example, may use pressurised fluid to drive the machine or to move a work tool, such as a boom or a shovel.

The hydraulic pump may draw fluid, for example oil, from a fluid reservoir and pressurises the fluid. The pressurised fluid may be directed through fluid lines of a circuit during machine operations. The hydraulic pump may be a variable displacement pump or a constant displacement pump.

The hydraulic systems may be closed loop circuits or open loop circuits for control of driving unit of the work machines. However, fluid flowing through the hydraulic circuit may escape through internal leaks in the pump and motor. Such leakage may result in a decrease of system pressure below acceptable margins. Further, fluid circulating in the fluid lines may overheat under heavy operation conditions. To compensate for leakage and overheated fluid, the circuits may have constant displacement pumps which are also known as charge pumps. The charge pumps may provide hydraulic power proportional to engine output at a constant pressure.

However, parasitic power losses may be a concern with all hydraulic systems including charge pumps. Unused excess hydraulic power may contribute to parasitic loss. Unused excess hydraulic power may occur during operating conditions where the fluid is pressurised to a level substantially greater than that required. Such an operating condition may occur when the charge pump pressurises fluid flow to the driving unit when the machine is stationery but undergoing a work operation. It has been observed that when the machine operates under such conditions, the pressurisation of the fluid may be significantly reduced.

The present disclosure is directed, at least in part, to improving or overcoming one or more aspects of the prior art system.

### BRIEF SUMMARY OF THE INVENTION

In a first aspect, the present disclosure describes a gearbox hydraulic circuit comprising a hydraulic pump connected to a fluid reservoir, the hydraulic pump being operable to generate a flow of pressurised fluid; a pressure circuit connected to the hydraulic pump to convey the flow of pressurised fluid, the pressure circuit having a first line and a second line; a pressure control valve disposed in the pressure circuit between the first line and the second line to maintain the pressure of the pressurised fluid in the first line; and a shunt connected to the pressure circuit, the shunt being operable to route the flow of pressurised fluid from the first line to the second line thereby reducing the pressure in the first line.

In a second aspect, the present disclosure describes a method of regulating fluid pressure in a gearbox hydraulic circuit comprising the steps of generating a flow of pressurised fluid with a hydraulic pump connected to a fluid reservoir, conveying the flow of pressurised fluid through a pressure circuit connected to the hydraulic pump, the pressure circuit having a first line and a second line; maintaining the pressure of the pressurised fluid in the first line with a pressure control valve disposed in the pressure circuit between the first line and the second line; and routing the flow of pressurised fluid from the first line to the second line through a shunt connected to the pressure circuit.

### BRIEF DESCRIPTION OF THE DRAWINGS

The foregoing and other features and advantages of the present disclosure will be more fully understood from the following description of various embodiments, when read together with the accompanying drawing, in which:

FIG. 1 is a schematic representation of a gearbox hydraulic circuit according to the present disclosure.

### DETAILED DESCRIPTION

This disclosure generally relates to a gearbox hydraulic circuit 10 for a work machine.

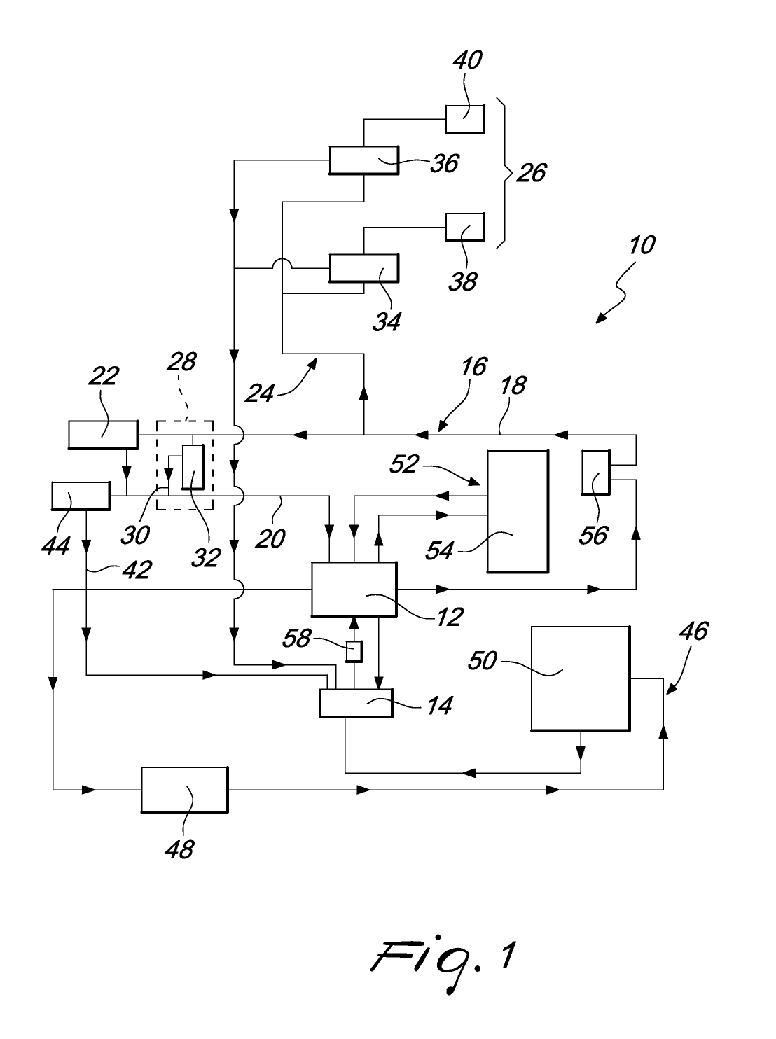

With reference to FIG. 1, the gearbox hydraulic circuit 10 may comprise a hydraulic pump 12. The hydraulic pump 12 may be disposed in a gearbox. The hydraulic pump 12 may generate a flow of pressurised fluid which may be required to operate gearbox systems. The pressurised fluid may be used to operate steering or driving units.

The hydraulic pump 12 may be a constant displacement charge pump, a variable displacement pump or fixed displacement variable flow pump.

Hydraulic pump 12 may include a pumping element which is operable to increase the pressure of the fluid. The pumping element may include a series of driven pistons. The pumping element may be a gear, or a vane pump. The hydraulic pump 12 may pressurise fluid to a pressure between 10 bar (1000 Kpa) to 30 bar (3000 Kpa). Preferably, the hydraulic pump 12 may pressurise fluid to a pressure between 15 bar (1500 Kpa) to 20 bar (2000 Kpa).

Preferably, the hydraulic pump 12 may pressurise fluid to a pressure of 16 bar (1600 Kpa).

The gearbox hydraulic circuit 10 may include a fluid reservoir 14 that contains a supply of fluid, such as an oil sump. Fluid reservoir 14 may also form a part of a lubrication system for the work machine. The fluid within fluid reservoir 14 may be a hydraulic fluid, for example, a lubricating oil. Fluid reservoir 14 may have other types of fluids.

Hydraulic pump 12 may have a housing with multiple inlets and outlets. An inlet may be connected to fluid reservoir 14 through a fluid line to receive fluid therefrom. Fluid from fluid reservoir 14 may be drawn therefrom as hydraulic pump 12 generates the pressurised fluid flow. A suction strainer 58 may be disposed in the fluid line through which fluid flows from fluid reservoir 14 to hydraulic pump 12.

An outlet of hydraulic pump 12 may be connected to fluid reservoir 14 through a fluid line. Fluid may flow from the outlet to fluid reservoir 14 through the fluid line.

In an embodiment, a supply pump may be provided in the gearbox hydraulic circuit 10. The supply pump may be a low pressure pump relative to the hydraulic pump 12, such as a sump pump. Supply pump may supply fluid to the hydraulic pump 12.

Gearbox hydraulic circuit 10 may comprise a pressure circuit 16. Pressure circuit 16 may be connected to an outlet of hydraulic pump 12. Pressurised fluid generated by hydraulic pump 12 may be conveyed through pressure circuit 16. Pressurised fluid may be conveyed to an inlet of the hydraulic pump 12.

Fluid in pressure circuit 16 may be directed to control units for control of gearbox systems, such as a steering system, a clutch system or a driving system.

Pressure circuit 16 may have a first line 18 connected to an outlet of the hydraulic pump 12. Pressure circuit 16 may have a second line 20 connected to an inlet of the hydraulic pump 12.

An oil filter 56 may be disposed in first line 18. Pressurised fluid from the hydraulic pump may flow through oil filter 56.

Gearbox hydraulic circuit 10 may comprise a pressure control valve 22. Pressure control valve 22 may be disposed in the pressure circuit 16. Pressure control valve 22 may be positioned between the first line 18 and the second line 20 of pressure circuit 16. Pressurised fluid flowing through first line 18 may enter an inlet of pressure control valve 22. Pressurised fluid may exit from an outlet of pressure control valve 22 and flow into second line 20 when pressure in first line 18 exceeds a predetermined value.

Pressure control valve 22 may maintain the pressure of the pressurised fluid in the first line 18. Pressure control valve 22 may maintain the pressurised fluid in the first line 18 at a pressure of fluid leaving the hydraulic pump 12. The pressure control valve 22 may maintain fluid pressure between 10 bar (1000 Kpa) to 30 bar (3000 Kpa). Preferably, the pressure control valve 22 may maintain fluid pressure between 15 bar (1500 Kpa) to 20 bar (2000 Kpa). Preferably, tpressure control valve 22 may maintain fluid pressure at 16 bar (1600 Kpa).

The pressure of the fluid in pressure circuit 16 may be maintained at a level for control of gearbox systems, such as clutch control or driving system, through respective control units.

Gearbox hydraulic circuit 10 may comprise a shunt 28. Shunt 28 may be connected to pressure circuit 16. Shunt 28 may be operable to route the flow of pressurised fluid from first line 18 to second line 20 of pressure circuit 16.

Shunt 28 may comprise a shunt line 30 which interconnects first line 18 and second line 20. Shunt 28 may comprise a shunt valve 32 disposed in shunt line 30. Shunt valve 32 may be connected in parallel to pressure control valve 22 within pressure circuit 16. Shunt valve 32 may be manually actuatable. Shunt valve 32 may be automatically actuatable.

Shunt valve 32 may be closed so that pressurised fluid may only leave first line 18 either through pressure control valve 22 or through fluid lines connected to control units. Shunt valve 32 may be actuated to open to allow pressurised fluid to flow through shunt line 30. The flow of pressurised fluid from first line 18 to second line 20 may reduce the overall pressure in the first line 18. Shunt valve 32 may be actuated to close when pressure in the first line 18 is required to return to a normal operating level for the control unit.

Gearbox hydraulic circuit 10 may further comprise a clutch rail 24. Clutch rail 24 may be connected to first line 18. Clutch rail 24 may convey the flow of pressurised fluid to a clutch control unit 26. In an embodiment, clutch rail 24 may convey a portion of the pressurised fluid flowing through first line 18 to a clutch control unit 26.

Clutch control unit 26 may comprise a first solenoid valve 34 and a second solenoid valve 36. Clutch rail 24 may further comprise fluid lines which carry pressurised fluid from first line 18 to first solenoid valve 34 and second solenoid valve 36. Clutch rail 24 may further comprise fluid lines which carry pressurised fluid from first solenoid valve 34 and second solenoid valve 36 to fluid reservoir 14.

Clutch control unit 26 may comprise a first clutch 38 and a second clutch 40. First solenoid valve 34 may control the flow of pressurised fluid to first clutch 38. Second solenoid valve 36 may control the flow of pressurised fluid to second clutch 40.

In an embodiment, first solenoid valve 34 may be a forward solenoid for controlling first clutch 38 which may be a forward clutch. Second solenoid valve 36 may be a reverse solenoid for controlling second clutch 40 which may be a reverse clutch.

In an embodiment, gearbox hydraulic circuit 10 may comprise a plurality of solenoid valves for controlling the flow of pressurised fluid to a plurality of clutches. In an embodiment, a clutch arrangement may have two forward clutches. A forward clutch may be for a low range and a second clutch may be for high range. In an embodiment, a clutch arrangement may have a forward, a reverse and three speed clutches.

In an embodiment, shunt line 30 may be connected to first line 18 between pressure control valve 22 and clutch rail 24. The point of connection of shunt line 30 may be located between pressure control valve 22, connected between first line 18 and second line 20, and the point of connection of the fluid line of clutch rail 24 and first line 18.

In an embodiment, shunt line 30 may be connected to first line 18 between hydraulic pump 12 and clutch rail 24. The point of connection of shunt line 30 may be located between hydraulic pump 12 and the point of connection of the fluid line of clutch rail 24 and first line 18.

Gearbox hydraulic circuit 10 may further comprise a relief line 42 which connects second line 20 and fluid reservoir 14. A relief valve 44 may be disposed in relief line 42.

Relief valve 44 may reduce the pressure of the pressurised fluid in second line 20 to a predetermined value by allowing fluid to flow through relief line 42 from second line 20 to fluid reservoir 14. The predetermined pressure for fluid in the second line 20 may be lower than the pressure of fluid in the first line 18.

Gearbox hydraulic circuit 10 may further comprise a torque converter circuit 52. Fluid lines may connect the hydraulic pump 12 to the torque converter 54. In an embodiment, second line 20 may be connected, through specific fluid paths within the hydraulic pump 12, to a fluid line of torque converter circuit 52. The fluid pressure in the fluid line leading to torque converter 54 may be substantially equal to the fluid pressure in second line 20.

A lubricant and cooling circuit 46 may be connected to the hydraulic pump 12. A fluid line may connect hydraulic pump 12 to an oil cooler 48. Fluid from oil cooler 48 may flow to a transmission 50. Fluid from transmission 50 may flow to fluid reservoir 14. The lubricant and cooling circuit 46 may be a component of the gearbox hydraulic circuit 10.

The pressure of fluid in the gearbox hydraulic circuit 10 may be regulated as required. A method of regulating fluid pressure in the gearbox hydraulic circuit 10 may comprise a step of generating a flow of pressurised fluid with a hydraulic pump 12 which is connected to a fluid reservoir 14 for supply of the fluid. The method may comprise conveying the flow of pressurised fluid through the pressure circuit 16 that is connected to the hydraulic pump 12. The pressure circuit 16 may have as fluid lines, the first line 18 and the second line 20. The method may comprise maintaining the pressure of the pressurised fluid in first line 18 with a pressure control valve 22 disposed in the pressure circuit 16 between first line 18 and second line 20. The method may comprise routing the flow of pressurised fluid from first line 18 to second line 20 through a shunt 28 connected to pressure circuit 16.

Shunt 28 may comprise shunt line 30 interconnecting first line 18 and second line 20 and a shunt valve 32 disposed in the shunt line 30. The flow of pressurised fluid may be routed through the shunt 28 when shunt valve 32 is actuated from closed to open. The flow of pressurised fluid through the shunt 28 may be stopped by actuating shunt valve 32 from opened to close.

The method may further comprise conveying flow of pressurised fluid to a clutch control unit 26 through a clutch rail 24 connected to the first line 18.

The skilled person would appreciate that foregoing embodiments may be modified or combined to obtain the gearbox hydraulic circuit 10 of the present disclosure.

### INDUSTRIAL APPLICABILITY

This disclosure describes a gearbox hydraulic circuit 10 which may reduce consumption of engine power. Gearbox hydraulic circuit 10 may reduce fluid pressure when such fluid pressure is not required.

Work machines, for example a backhoe loader, may be stationery when the work tool or implement, for example a backhoe, is being operated. In this situation the gearbox may not be in use as the work machine is not moving. Pressurised fluid may not be required in the clutch rail 24. Even though the machine is stationery the hydraulic pump 12 may continue to be driven.

The fluid pressure is maintained in the pressure circuit 16 by hydraulic pump 12 and pressure control valve 22. The engine power is consumed by hydraulic pump 12 which works against the pressurised fluid in the pressure circuit 16. Thus engine power is consumed by the hydraulic pump 12 even when the pressure is not required.

The shunt 28 may be actuated to allow pressurised fluid to flow through an alternative route bypassing the pressure control valve 22 thereby decreasing the pressure of the fluid in the pressure circuit 16. The decrease in fluid pressure reduces the amount power consumed by hydraulic pump 12.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

Where technical features mentioned in any claim are followed by references signs, the reference signs have been included for the sole purpose of increasing the intelligibility of the claims and accordingly, neither the reference signs nor their absence have any limiting effect on the technical features as described above or on the scope of any claim elements.

One skilled in the art will realise the disclosure may be embodied in other specific forms without departing from the disclosure or essential characteristics thereof. The foregoing embodiments are therefore to be considered in all respects illustrative rather than limiting of the disclosure described herein. Scope of the invention is thus indicated by the appended claims, rather than the foregoing description, and all changes that come within the meaning and range of equivalence of the claims are therefore intended to be embraced therein.

The disclosures in European Patent Application No. 12172597.2 from which this application claims priority are incorporated herein by reference.

1. A gearbox hydraulic circuit comprising:
a hydraulic pump connected to a fluid reservoir, the hydraulic pump being operable to generate a flow of pressurised fluid;
a pressure circuit connected to the hydraulic pump to convey the flow of pressurised fluid, the pressure circuit having a first line and a second line;
a pressure control valve disposed in the pressure circuit between the first line and the second line to maintain the pressure of the pressurised fluid in the first line; and
a shunt connected to the pressure circuit, the shunt being operable to route the flow of pressurised fluid from the first line to the second line.

2. The gearbox hydraulic circuit of claim 1 wherein the shunt comprises a shunt line interconnecting the first line and the second line and a shunt valve disposed in the shunt line.

3. The gearbox hydraulic circuit of claim 2 wherein shunt valve is connected in parallel to the pressure control valve.

4. The gearbox hydraulic circuit of claim 1 further comprising a clutch rail connected to the first line to convey the flow of pressurised fluid to a clutch control unit.

5. The gearbox hydraulic circuit of claim 4 wherein the clutch control unit comprises first and second solenoid valves to control flow of pressurised fluid to first and second clutches.

6. The gearbox hydraulic circuit of claim 4 wherein the first and second solenoid valves are forward and reverse valves and first and second clutches are forward and reverse clutches.

7. The gearbox hydraulic circuit of claim 4 wherein the shunt line is connected to the first line between the pressure control valve and the clutch rail.

8. The gearbox hydraulic circuit of claim 4 wherein the shunt line is connected to the first line between the clutch rail and the hydraulic pump.

9. The gearbox hydraulic circuit of claim 2 wherein the shunt valve is manually actuatable.

10. The gearbox hydraulic circuit of claim 2 wherein the shunt valve is automatically actuatable.

11. The gearbox hydraulic circuit of claim 1 wherein the hydraulic pump is a constant displacement pump.

12. A work machine comprising a gearbox hydraulic circuit of claim 1.

13. A method of regulating fluid pressure in a gearbox hydraulic circuit according to claim 1, the method comprising the steps of:
generating a flow of pressurised fluid with a hydraulic pump connected to a fluid reservoir,
conveying the flow of pressurised fluid through a pressure circuit connected to the hydraulic pump, the pressure circuit having a first line and a second line;
maintaining the pressure of the pressurised fluid in the first line with a pressure control valve disposed in the pressure circuit between the first line and the second line; and
routing the flow of pressurised fluid from the first line to the second line through a shunt connected to the pressure circuit.

14. The method of claim 13 wherein the shunt comprises a shunt line interconnecting the first line and the second line and a shunt valve disposed in the shunt line.

15. The method of claim 13 further comprising the step of conveying flow of pressurised fluid to a clutch control unit through a clutch rail connected to the first line.

16. The method of claim 14 further comprising the step of conveying flow of pressurised fluid to a clutch control unit through a clutch rail connected to the first line.

17. The gearbox hydraulic circuit of claim 4 wherein the shunt valve is manually actuatable.

18. The gearbox hydraulic circuit of claim 4 wherein the shunt valve is automatically actuatable.

19. The gearbox hydraulic circuit of claim 2 wherein the hydraulic pump is a constant displacement pump.

20. A work machine comprising a gearbox hydraulic circuit of claim 2.
